(19) United States
(12) Patent Application Publication
(10) Pub. No.: US 2025/0011517 A1
(43) Pub. Date: Jan. 9, 2025

(54) ELASTIC (METH)ACRYLATE COMPOSITION WITH IMPROVED ADHESION ON OILY SUBSTRATES

(71) Applicant: SIKA TECHNOLOGY AG, Baar (CH)

(72) Inventors: Denise STORRER, Zürich (CH); Fabien CHOFFAT, Rüttenen (CH)

(73) Assignee: SIKA TECHNOLOGY AG, Baar (CH)

(21) Appl. No.: 18/708,678

(22) PCT Filed: Nov. 21, 2022
(86) PCT No.: PCT/EP2022/082581

§ 371 Date: May 9, 2024

(30) Foreign Application Priority Data
Dec. 9, 2021 (EP) 21213314.4

(51) Int. Cl. C08F 290/06; C08G 18/67; C08K 3/26; C08K 3/36; C08K 5/13; C08K 5/14; C08K 5/18; C08K 5/521; C09J 4/06; C09J 5/04

(52) U.S. Cl. CPC C08F 290/067; C08G 18/673; C08K 3/26; C08K 3/36; C08K 5/13; C08K 5/14; C08K 5/18; C08K 5/521; C09J 4/06; C09J 5/04; C08K 2003/265; C09J 2400/163

(57) ABSTRACT

A two-component composition, component K1, including at least one (meth)acrylate monomer, at least one elastomer having (meth)acrylate end groups, at least one additive selected from the group consisting of activator for free-radical curing, inhibitor for free-radical curing, filler and adhesion promoter; and a component K2 including at least one initiator for free-radical curing wherein the elastomer is a polyurethane (meth)acrylate produced from the reaction of at least one diol including at least one dimer fatty acid-based polyester diol with at least one diisocyanate and a (meth)acrylic acid, a (meth)acrylamide or a (meth)acrylate ester having a hydroxyl group, wherein the at least one diol initially reacts with the diisocyanate which is present in stoichiometric excess and the resulting isocyanate-terminated polyurethane is subsequently reacted with the (meth)acrylic acid, the (meth)acrylamide or the (meth)acrylate ester having a hydroxyl group to afford the elastomer.

### TECHNICAL FIELD

The present invention relates to the field of two-component (meth)acrylate compositions, especially suitable as adhesives.

### PRIOR ART

(Meth)acrylate compositions have long been used in particular as structural or semi-structural adhesives since they have good mechanical and optical stability and especially allow very good adhesion to many substrates. However, for structural bonding elastic properties are also important, especially in applications that are subject to thermal or mechanical stress. Different approaches have been adopted to increase the flexibility and impact strength of (meth)acrylate compositions that otherwise are brittle and have very low breaking elongations, thus broadening their utility to further applications. Thus for example U.S. Pat. No. 3,994,764 describes the addition of non-reactive elastomers solid at room temperature to the (meth)acrylate composition. The disadvantage of such compositions is that the (meth)acrylate monomers must be selected such that the solid elastomer dissolves in them, since it is not chemically incorporated into the (meth)acrylate matrix. Only methyl methacrylate meets this requirement to a suitable extent, this in turn having the disadvantage that it exudes a very unpleasant odor during use and is highly flammable. One way to improve the compatibility of elastomers with the (meth)acrylate matrix is to modify the elastomers with olefinic reactive groups which, via the free-radical curing of the (meth)acrylate monomers, are incorporated into the resulting network.

The addition of such reactive elastomers liquid at room temperature to the (meth)acrylate composition to improve flexibility is described, for example, in U.S. Pat. No. 4,769,419. Furthermore, U.S. Pat. No. 4,439,600 for example describes the addition of polyurethane polymers functionalized with (meth)acrylates. Such compositions in some cases have the disadvantage that they exhibit viscoelastic behavior after curing and undergo plastic deformation under stress.

WO 02/070619 describes elastic (meth)acrylate compositions comprising a monofunctional (meth)acrylate monomer having a high glass transition temperature (Tg), a monofunctional (meth)acrylate co-monomer and a liquid elastomer. However, it was surprisingly found that, due to the strong plasticizing effect of a large part of the co-monomers contained therein, such compositions exhibit insufficient adhesive properties on certain substrates and have therefore proven unsuitable especially for the bonding of glass with polyvinyl chloride (PVC) and/or aluminum.

WO2008151849 describes elastic (meth)acrylate compositions comprising a first (meth)acrylate monomer selected from a specific list, preferably methyl methacrylate (MMA) and tetrahydrofurfuryl methacrylate (THFMA), and a second (meth)acrylate monomer, which is ethylhexyl acrylate (EHA) or maleic acid diallyl ester (MADAE), and additionally an elastomer. Although the compositions taught in this publication have improved elastic properties, they are particularly suitable for structural and semi-structural applications, for example for the bonding of glass with PVC and/or aluminum.

The above publications generally describe (meth)acrylate compositions having improved elasticity and sometimes excellent adhesion on many substrates. However, it has been shown that the known compositions as described above show a lack of adhesion on certain substrates, especially when formulated without methyl methacrylate (MMA), which is increasingly required. Especially on oily substrates, for example metals with residues of process oils or greases on their surface, severe weaknesses in adhesion are apparent. It is true that it is possible to prepare oily or greasy surfaces for sufficient adhesion through laborious cleaning. However, this requires the use of solvents and time-consuming additional operating steps, which is economically and ecologically undesirable and in some cases impracticable.

There is accordingly still a need for a (meth)acrylate composition which has a high elasticity and is suitable for structural bonding but at the same time allows exceptional adhesion even to oily substrates, and can be formulated without volatile, strongly unpleasant smelling monomers such as MMA.

### SUMMARY OF THE INVENTION

It is accordingly an object of the present invention to provide two-component (meth)acrylate compositions which due to their optimal elastic properties are suitable for structural and semi-structural applications and which also exhibit exceptional adhesion to oily substrates, for example to aluminum alloys such as AlMg₃. Furthermore, these compositions shall be formulated without the use of volatile and odor-intensive (meth)acrylate monomers such as MMA.

It has now been found that, surprisingly, this object is achieved by compositions as claimed in claim 1.

These compositions have a very high elasticity and exceptional strength which allows them to establish high-strength, durable adhesion even to oily substrates. The compositions according to the invention have tensile shear strengths measured according to ISO 4587/DIN EN 1465 at 23° C. of at least 9.5 MPa, preferably at least 10 MPa, in particular at least 10.5 MPa or higher, in each case with an at least predominantly or exclusively cohesive fracture pattern.

Further aspects of the invention are the subject of further independent claims. Particularly preferred embodiments of the invention are the subject of the dependent claims.

### WAYS OF EXECUTING THE INVENTION

The present invention relates to a two-component composition, component K1, comprising
a) at least one (meth)acrylate monomer A;
b) at least one elastomer C having (meth)acrylate end groups;
c) preferably at least one additive selected from the group consisting of activator for free-radical curing, inhibitor for free-radical curing, filler and adhesion promoter;
and a component K2 comprising at least one initiator for free-radical curing;
characterized in that the elastomer C is a polyurethane (meth)acrylate produced from the reaction of at least one diol D comprising at least one dimer fatty acid-based polyester diol with at least one diisocyanate and a (meth)acrylic acid, a (meth)acrylamide or a (meth)acrylate ester having a hydroxyl group, wherein preferably
   the at least one diol D initially reacts with the diisocyanate which is present in stoichiometric excess;
   and the resulting isocyanate-terminated polyurethane is subsequently reacted with the (meth)acrylic acid, the (meth)acrylamide or the (meth)acrylate ester having a hydroxyl group to afford the elastomer C.

In the present document substance names beginning with “poly”, for example polyisocyanate, polyurethane, polyester or polyol, refer to substances formally containing two or more of the eponymous functional groups per molecule. The term “polymer” in the present document encompasses firstly a collective of macromolecules that are chemically uniform, but differ in their degree of polymerization, molar mass, and chain length, said macromolecules having been produced by a poly reaction (polymerization, polyaddition, polycondensation). The term secondly also encompasses derivatives of such a collective of macromolecules from poly reactions, i.e. compounds obtained by reactions, for example additions or substitutions, of functional groups in defined macromolecules and which may be chemically uniform or chemically nonuniform. The term moreover also encompasses so-called prepolymers, i.e. reactive oligomeric preliminary adducts whose functional groups are involved in the formation of macromolecules.

The term “polymeric polyol” in the present document encompasses any polymer as defined above which comprises more than one hydroxyl group. Accordingly, the term “polymeric diol” encompasses any polymer having precisely two hydroxyl groups.

The term “polyurethane polymer” encompasses all polymers produced by the so-called diisocyanate polyaddition process. This also includes polymers that are virtually or completely free from urethane groups. Examples of polyurethane polymers are polyether polyurethanes, polyester polyurethanes, polyether polyureas, polyureas, polyester polyureas, polyisocyanurates, and polycarbodiimides.

“Molecular weight” in the present document is to be understood as meaning the defined and discrete molar mass (in grams per mole) of a molecule or part of a molecule, also referred to as a “radical”. “Average molecular weight” denotes the number-average Mₙ of an especially polydisperse, oligomeric or polymeric mixture of molecules or radicals which is typically determined by gel permeation chromatography (GPC) against a polystyrene as standard.

The term “(meth)acrylate” is to be understood as meaning “methacrylate” or “acrylate”.

A dashed line in the formulae in this document in each case represents the bond between a substituent and the accompanying molecular radical unless otherwise stated.

“Room temperature” refers to a temperature of approx. 23° C.

Unless otherwise stated, all industry standards or other standards mentioned in this document relate to the version of the industry standard or other standard that was valid at the time of filing of the patent application.

The terms “mass” and “weight” are used synonymously in this document. Thus a “percentage by weight” (% by weight) is a percentage mass fraction which unless otherwise stated relates to the mass (the weight) of the total composition or, depending on the context, of the entire molecule.

The two-component composition according to the invention consists of a first component K1 and a second component K2.

Component K1 firstly comprises at least one (meth)acrylate monomer A.

(Meth)acrylate monomer A may comprise all (meth)acrylate monomers typically employed in (meth)acrylate adhesives.

However, (meth)acrylate monomer A preferably does not comprise methyl methacrylate (MMA) since this is problematic in respect of its high vapor pressure, highly flammable nature, unpleasant odor and questionable health effects.

(Meth)acrylate monomer A especially comprises at least one (meth)acrylate monomer according to formula (IIIa),

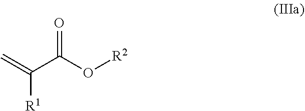

wherein R¹ is either a hydrogen atom or a methyl group, preferably a methyl group;

R² is either an isobornyl group or a linear or branched hydroxyalkyl group having 2 to 6 carbon atoms or a radical having 4 to 8 carbon atoms comprising either a phenyl group or an aliphatic 5- or 6-membered ring with at least one ether oxygen in the ring structure.

R¹ in formula (IIIa) is preferably a methyl group.

In a preferred embodiment R² in formula (IIIa) is a linear or branched hydroxyalkyl group having 2 to 4 carbon atoms. Examples of such monomers are hydroxypropyl acrylate (HPA), hydroxypropyl methacrylate (HPMA), hydroxybutyl acrylate (HBA) or hydroxybutyl methacrylate (HBMA), preferably hydroxyethyl acrylate (HEA) or hydroxyethyl methacrylate (HEMA), wherein hydroxyethyl methacrylate (HEMA) is particularly preferred.

In another preferred embodiment R² in formula (IIIa) is a radical having 4 to 8 carbon atoms which comprises an aliphatic 5- or 6-membered ring having one or two ether oxygens in the ring structure.

In another preferred embodiment R² in formula (IIIa) is an isobornyl group.

It is most preferable when R² in formula (IIIa) is an isobornyl group or a hydroxyethyl group or a benzyl group or at least one of the groups (IVa) to (IVc) in formula (IV),

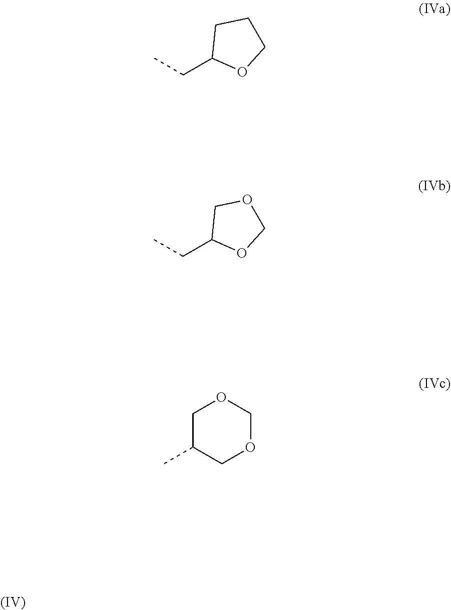

wherein the dashed lines in formula (IV) represent the bond between the oxygen atom and R². Examples of such preferred monomers include isobornyl acrylate (IBOA), isobornyl methacrylate (IBOMA), benzyl acrylate (BNA), benzyl methacrylate (BNMA), hydroxyethyl acrylate (HEA), hydroxyethyl methacrylate (HEMA), tetrahydrofurfuryl methacrylate (THFMA) and the isomer mixture glycerol formal methacrylate (comprising the structures (IVb) and (IVc) in formula (IV); CAS-No. 1620329-57-8) which is available from Evonik under the trade name GLYFOMA.

The most preferred monomers according to formula (IIIa) are isobornyl methacrylate (IBOMA), benzyl methacrylate (BNMA), tetrahydrofurfuryl methacrylate (THFMA), hydroxyethyl methacrylate (HEMA) and glycerol formal methacrylate (GLYFOMA).

It goes without saying that mixtures of these monomers according to formula (IIIa) may also be employed.

(Meth)acrylate monomer A especially comprises at least one (meth)acrylate monomer according to formula (IIIb),

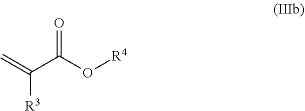

wherein R³ is either a hydrogen atom or a methyl group, preferably a methyl group; and

R⁴ is a linear alkyl radical having more than 12 carbon atoms in the chain and preferably at most 20 carbon atoms in the chain.

R³ in formula (IIIb) is preferably a methyl group.

R⁴ in formula (IIIb) is preferably a linear alkyl radical having 13 to 18 carbon atoms in the chain. If there is a mixture of different chain lengths in the radical R⁴ the average value of the chain lengths is formally used as a measure of the effective chain length in R⁴.

Examples of such (meth)acrylate monomers according to formula (IIIb) include lauryl tetradecyl acrylate (LATEA), lauryl tetradecyl methacrylate (LATEMA), stearyl acrylate (STEA) and stearyl methacrylate (STEMA). Lauryl tetradecyl methacrylate (LATEMA) and stearyl methacrylate (STEMA) are most preferred.

Component K1 preferably contains between 25% by weight and 75% by weight, preferably between 35% by weight and 60% by weight, based on component K1, of (meth)acrylate monomer A.

If mixtures of (meth)acrylate monomers according to formula (IIIa) and (meth)acrylate monomers according to formula (IIIb) are used as (meth)acrylate monomer A the weight ratio of (meth)acrylate monomers according to formula (IIIa) and (meth)acrylate monomers according to formula (IIIb) is preferably between 1:1 and 9:1, preferably between 6:4 and 8:2. Within these limits it is possible to achieve improved elasticity both at room temperature and at very low temperatures down to −20° C.

Component K1 further contains at least one elastomer C having (meth)acrylate end groups. The elastomer C is a polyurethane (meth)acrylate produced from the reaction of at least one diol D comprising at least one dimer fatty acid-based polyester diol with at least one diisocyanate and a (meth)acrylic acid, a (meth)acrylamide or a (meth)acrylate ester having a hydroxyl group, wherein preferably
the at least one diol D initially reacts with the diisocyanate which is present in stoichiometric excess;
and the resulting isocyanate-terminated polyurethane is subsequently reacted with the (meth)acrylic acid, the (meth)acrylamide or the (meth)acrylate ester having a hydroxyl group to afford the elastomer C.

In the second step it is preferable to employ a (meth)acrylate ester having a hydroxyl group.

Component K1 preferably contains between 10% by weight and 30% by weight, in particular between 15% by weight and 25% by weight, based on component K1, of elastomer C.

Elastomer C is preferably at least one elastomer according to formula (I),

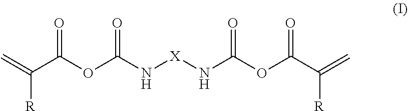

wherein R is either a hydrogen atom or a methyl group and

X is a polymer radical containing dimer fatty acid-based polyester structural fractions.

Elastomer C preferably has an average molecular weight Mₙ measured by gel permeation chromatography (GPC) of 2000 to 5000 g/mol, in particular of 2500 to 4500 g/mol.

In elastomer C of formula (I) radical X is a polyurethane polymer after removal of two NCO groups, wherein this polyurethane polymer is produced from the reaction of at least one diol D comprising at least one dimer fatty acid-based polyester diol with at least one diisocyanate, wherein the diisocyanate is employed in molar excess, preferably in at least twice the molar amount relative to all employed diols D.

Elastomer C is therefore a polyurethane (meth)acrylate. Such compounds are producible from the reaction of at least one diol D with at least one diisocyanate and a (meth)acrylic acid, a (meth)acrylamide or a (meth)acrylate ester having a hydroxyl group.

In a first preferred process this reaction may be carried out by reacting the diol D and the diisocyanate by customary processes, for example at temperatures of 50° C. to 100° C., optionally with co-use of suitable catalysts, ensuring that the NCO groups are present in stoichiometric excess relative to the OH groups.

The isocyanate-terminated polyurethane polymer resulting from this reaction is then reacted with a (meth)acrylic acid, a (meth)acrylamide or with a (meth)acrylate ester having a hydroxyl group, in particular with a hydroxyalkyl (meth)acrylate such as hydroxypropyl acrylate (HPA), hydroxypropyl methacrylate (HPMA), hydroxybutyl acrylate (HBA) or hydroxybutyl methacrylate (HBMA), preferably with hydroxyethyl acrylate (HEA) or hydroxyethyl methacrylate (HEMA), or with a monohydroxypoly(meth)acrylate of a polyol, preferably of glycerol or trimethylolpropane, to afford a polyurethane (meth)acrylate.

In a second process the diol D may be reacted with the diisocyanate, wherein the OH groups are present in stoichiometric excess relative to the NCO groups. The hydroxyl-terminated polyurethane polymer resulting from this reaction may be esterified with a (meth)acrylic acid to afford the elastomer C of formula (I). A further process for producing the elastomer C comprises a first step of reacting the (meth)acrylic acid, the (meth)acrylamide or the (meth)acrylate ester having a hydroxyl group, in particular hydroxyalkyl (meth)acrylate such as hydroxypropyl acrylate (HPA), hydroxypropyl methacrylate (HPMA), hydroxybutyl acrylate (HBA) or hydroxybutyl methacrylate (HBMA), preferably hydroxyethyl acrylate (HEA) or hydroxyethyl methacrylate (HEMA), or a monohydroxypoly(meth)acrylate of a polyol, preferably of glycerol or trimethylolpropane, with at least one diisocyanate which is employed in an amount such that the NCO groups are present in excess relative to the OH groups. In a subsequent reaction the resulting intermediate comprising an isocyanate group is reacted with at least one diol D to afford the elastomer C.

It is also possible to produce the elastomer C by esterification of a (meth)acrylic acid with a diol D, wherein the diol is present in stoichiometric excess. In a subsequent reaction the partially esterified diol D reacts with a diisocyanate to afford the elastomer C.

In all production cases diol D must comprise or consist of at least one dimer fatty acid-based polyester diol.

The dimer fatty acid-based polyester diol used for the reaction is typically liquid at room temperature. It has an OH number in the range from 28 to 120 mg KOH/g.

Such dimer fatty acid-based polyester diols have an average molecular weight Mₙ in the range from 950 to 4000 g/mol. They have a largely linear structure and an average OH functionality of about 2.

The dimer fatty acid-based polyester diol is preferably amorphous.

Suitable dimer fatty acid-based polyester diols are especially obtained from the esterification of at least one dimer fatty acid and/or at least one dimer fatty alcohol with a diol, for example diethylene glycol or butanediol, and/or a dicarboxylic acid, for example adipic acid, at such a stoichiometry that the product is amorphous and is liquid at room temperature and has an OH number in the range from 28 to 120 mg KOH/g.

The dimer fatty acid-based polyester diol preferably contains a content of carbon atoms from renewable sources according to ASTM D6866 based on the total carbon content in the range from 50% to 100%, preferably 60% to 95%, especially 70% to 90%. Such a polyester diol is amorphous and hydrophobic and has particularly good compatibility in (meth)acrylate-based adhesives.

The dimer fatty acid-based polyester diol preferably has an OH number in the range from 34 to 120 mg KOH/g, especially 52 to 60 mg KOH/g. Such a dimer fatty acid-based polyester diol has an average molecular weight Mₙ in the range from 950 to 3300 g/mol, especially in the range from 1900 to 2200 g/mol. Such a polymer allows (meth)acrylate compositions having a particularly attractive combination of easy application, good adhesion properties and high strength.

Especially suitable are commercially available amorphous dimer fatty acid-based polyester diols, especially the following grades obtainable under the Priplast® trade name: Priplast® 1837, 1838, 3187, 3196, 3197, 3199 or 3238 (from Croda). Priplast® 1837, 1838 und 3196 are preferred.

In a preferred embodiment of the reaction of diol D and diisocyanate an NCO:OH ratio of at least 3:1 is established.

The NCO:OH ratio is preferably in the range from 3:1 to 10:1, more preferably 3:1 to 8:1, especially 4:1 to 7:1, most preferably 5:1 to 7:1.

The reaction is preferably performed in the absence of moisture at a temperature in the range from 20° C. to 160° C., in particular 40° C. to 140° C., optionally in the presence of suitable catalysts.

After the reaction, the monomeric diisocyanate remaining in the reaction mixture is removed by means of a suitable separation method down to the residual content described.

A preferred separation method is a distillative method, especially thin-film distillation or short-path distillation, preferably with application of reduced pressure.

Particular preference is given to a multistage method in which the monomeric diisocyanate is removed in a short-path evaporator with a jacket temperature in the range from 120° C. to 200° C. and a pressure of 0.001 to 0.5 mbar.

In the case of 4,4′-MDI, which is preferred as monomeric diisocyanate, distillative removal is particularly demanding. It has to be ensured, for example, that the condensate does not solidify and block the system. Preference is given to operating at a jacket temperature in the range from 160° C. to 200° C. at 0.001 to 0.5 mbar and condensing the monomer removed at a temperature in the range from 40° C. to 60° C.

Preference is given to reacting the monomeric diisocyanate with the diol D comprising dimer fatty acid-based polyester diol and subsequently removing the majority of the monomeric diisocyanate remaining in the reaction mixture without the use of solvents or entraining agents.

Preference is given to subsequently reusing the monomeric diisocyanate removed after the reaction, i.e. using it again for the production of isocyanate-containing polymer.

The reaction comprises reacting the OH groups of the diol D comprising dimer fatty acid-based polyester diol with the isocyanate groups of the monomeric diisocyanate. This also results in so-called chain extension reactions comprising reaction of OH groups and/or isocyanate groups of reaction products between diol D and monomeric diisocyanate. The higher the NCO:OH ratio chosen, the lower the level of chain extension reactions that takes place, and the lower the polydispersity and hence also the viscosity of the polymer obtained. A measure of the chain extension reaction is the average molecular weight of the polymer, or the breadth and distribution of the peaks in the GPC analysis. A further measure is the effective NCO content of the polymer freed from monomers relative to the theoretical NCO content calculated from the reaction of every OH group with a monomeric diisocyanate.

In addition to dimer fatty acid-based polyester diol, diol D may also comprise further diols, in particular:
polyether diols, especially polyoxyalkylene diols, especially polymerization products of ethylene oxide or 1,2-propylene oxide or 1,2- or 2,3-butylene oxide or oxetane or tetrahydrofuran or mixtures thereof, where these may be polymerized with the aid of a starter molecule having two active hydrogen atoms, especially a starter molecule such as water or a compound having two OH or NH groups, for example ethane-1,2-diol, propane-1,2- or -1,3-diol, neopentyl glycol, diethylene glycol, triethylene glycol, the isomeric dipropylene glycols or tripropylene glycols, the isomeric butanediols, pentanediols, hexanediols, heptanediols, octanediols, nonanediols, decanediols, undecanediols, cyclohexane-1,3- or -1,4-dimethanol, bisphenol A, hydrogenated bisphenol A, or aniline, or mixtures of the aforementioned compounds. Also suitable are polyether diols having polymer particles dispersed therein, especially styrene-acrylonitrile particles (SAN) or polyurea or polyhydrazodicarbonamide (PHD) particles.
polyester diols, especially from the polycondensation of hydroxycarboxylic acids or especially those produced from dihydric alcohols, for example ethylene glycol, diethylene glycol, propylene glycol, dipropylene glycol, neopentyl glycol, butane-1,4-diol, pentane-1,5-diol, 3-methylhexane-1,5-diol, hexane-1,6-diol, octane-1,8-diol, decane-1,10-diol, dodecane-1,12-diol, 1,12-hydroxystearyl alcohol, 1,4-cyclohexanedimethanol, dimer fatty acid diol (dimer diol), neopentyl glycol hydroxypivalate, or mixtures of the aforementioned alcohols with organic dicarboxylic acids or anhydrides or esters thereof, such as especially succinic acid, glutaric acid, adipic acid, trimethyladipic acid, suberic acid, azelaic acid, sebacic acid, dodecanedicarboxylic acid, maleic acid, fumaric acid, dimer fatty acid, phthalic acid, phthalic anhydride, isophthalic acid, terephthalic acid, dimethyl terephthalate, hexahydrophthalic acid or mixtures of the aforementioned acids, and also polyester polyols formed from lactones such as especially-caprolactone and starters such as the aforementioned dihydric alcohols.
polycarbonate diols, as obtainable by reaction for example of the aforementioned alcohols used to form the polyester polyols with dialkyl carbonates, diaryl carbonates or phosgene.
block copolymers bearing two hydroxyl groups and comprising at least two different blocks of polyether, polyester and/or polycarbonate structure of the above-described type, especially polyether polyester diols.
polyacrylate and polymethacrylate diols.
polyhydrocarbon diols, also known as oligohydrocarbonols, such as, for example, dihydroxy-functional polyolefins, polyisobutylenes, polyisoprenes; dihydroxy-functional ethylene/propylene, ethylene/butylene or ethylene/propylene/diene copolymers, as produced, for example, by Kraton Polymers; dihydroxy-functional polymers of dienes, especially of 1,3-butadiene, which can especially also be prepared from anionic polymerization; dihydroxy-functional copolymers of dienes, such as 1,3-butadiene, or diene mixtures and vinyl monomers, such as styrene, acrylonitrile, vinyl chloride, vinyl acetate, vinyl alcohol, isobutylene and isoprene, for example dihydroxy-functional acrylonitrile/butadiene copolymers, as may be produced, for example, from epoxides or aminoalcohols and carboxyl-terminated acrylonitrile/butadiene copolymers (commercially available, for example, under the name Hypro® CTBN or CTBNX or ETBN from Emerald Performance Materials); and hydrogenated dihydroxy-functional polymers or copolymers of dienes.

Preferred diols D include not only dimer fatty acid-based polyester diol but also polybutadiene diols having an average molecular weight in the range from 2000 to 10 000 g/mol.

The average molecular weight of the polybutadiene diol is preferably in the range from 2000 to 4000 g/mol, in particular in the range from 2500 to 3000 g/mol.

A suitable polybutadiene diol is especially obtainable by polymerization of 1,3-butadiene and allyl alcohol in a suitable ratio or by oxidation of suitable polybutadienes.

A suitable polybutadiene polyol especially contains structural elements of formula (IIIa) and optionally structural elements of formula (IIIb) or (IIIc).

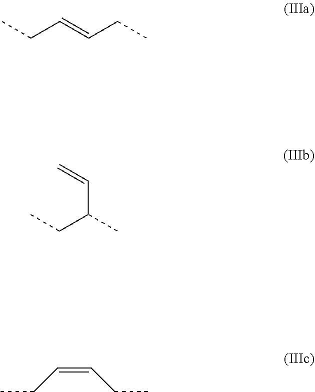

A preferred polybutadiene diol contains

40% to 80%, especially 55% to 65%, of the structural element of formula (IIIa),

0% to 30%, especially 15% to 25%, of the structural element of formula (IIIb),

0% to 30%, especially 15% to 25%, of the structural element of formula (IIIc).

Such polybutadiene diols are obtainable under the trade names Poly bd® or Krasol® (both from Cray Valley).

Further preferred diols D other than dimer fatty acid-based polyester diol include polyoxyalkylene diols, also known as “polyether diols”, polyester diols, polycarbonate diols and mixtures thereof. The most preferred diols among these are polyoxyethylene diols, polyoxypropylene diols or polyoxybutylene diols.

The polyoxyalkylene diols may have different degrees of unsaturation (measured according to ASTM D-2849-69 and reported in milliequivalents of unsaturation per gram of polyol (mEq/g)). Those with a low degree of unsaturation are produced for example using so-called double metal cyanide complex catalysts (DMC catalysts) while those with a higher degree of unsaturation are produced for example using anionic catalysts such as NaOH, KOH, CsOH or alkali metal alkoxides.

The use of polyoxyalkylene diols having a low degree of unsaturation, in particular of less than 0.01 mEq/g, is preferred for diols having a molecular weight of ≥2000 g/mol.

Diisocyanates suitable for the production of elastomer C in principle include all diisocyanates. Suitable examples include hexamethylene 1,6-diisocyanate (HDI), 2-methylpentamethylene 1,5-diisocyanate, 2,2,4- and 2,4,4-trimethylhexamethylene 1,6-diisocyanate (TMDI), dodecamethylene 1,12-diisocyanate, lysine and lysine ester diisocyanate, cyclohexane 1,3-diisocyanate, cyclohexane 1,4-diisocyanate, 1-isocyanato-3,3,5-trimethyl-5-isocyanatomethylcyclohexane (=isophorone diisocyanate or IPDI), perhydro-2,4′-diphenylmethane diisocyanate and perhydro-4,4′-diphenylmethane diisocyanate, 1,4-diisocyanato-2,2,6-trimethylcyclohexane (TMCDI), 1,3- and 1,4-bis(isocyanatomethyl)cyclohexane, m- and p-xylylene diisocyanate (m- and p-XDI), m- and p-tetramethyl-1,3-xylylene diisocyanate, m- and p-tetramethyl-1,4-xylylene diisocyanate, bis(1-isocyanato-1-methylethyl) naphthalene, tolylene 2,4-diisocyanate and 2,6-diisocyanate (TDI), diphenylmethane 4,4′-diisocyanate, 2,4′-diisocyanate, and 2,2′-diisocyanate (MDI), phenylene 1,3-diisocyanate and 1,4-diisocyanate, 2,3,5,6-tetramethyl-1,4-diisocyanatobenzene, naphthalene 1,5-diisocyanate (NDI), 3,3′-dimethyl-4,4′-diisocyanatobiphenyl (TODI), oligomers and polymers of the abovementioned isocyanates and also any desired mixtures of the aforementioned isocyanates. 1-isocyanato-3,3,5-trimethyl-5-isocyanatomethyl-cyclohexane (IPDI) is a preferred diisocyanate.

It is preferable when the composition in component K1 additionally contains between 0.5% by weight and 5% by weight, based on component K1, of an adhesion promoter, in particular selected from the list of organosilanes, metal (meth)acrylates, preferably metal (meth)acrylates of calcium, magnesium or zinc, polyfunctional (meth)acrylates having more than two (meth)acrylate groups and (meth)acrylates of formula (II).

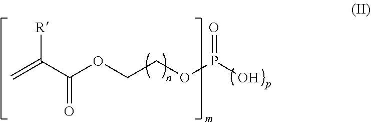

The radical R′ is either a hydrogen atom or a methyl group, n represents a value of 1 to 15, in particular of 1 to 5, preferably of 1 to 3, m represents a value of 1 to 3 and p represents a value of 3 minus m.

Preferred metal (meth)acrylates are metal (meth)acrylates of calcium, magnesium or zinc having a hydroxyl group and/or (meth)acrylic acid or (meth)acrylate as a ligand or anion. Particularly preferred metal (meth)acrylates are zinc (meth)acrylate, calcium (meth)acrylate, Zn (OH) (meth)acrylate and magnesium (meth)acrylate.

Preferred (meth)acrylates of formula (II) are 2-methacryloyloxyethyl phosphate, bis(2-methacryloyloxyethyl) phosphate and tris(2-methacryloyloxyethyl) phosphate and mixtures thereof.

Preferred organosilanes are epoxy-functional silanes, in particular 3-glycidoxypropyltrimethoxysilane.

Adhesion promoters are used to improve adhesion to special substrates. The use of phosphorus-containing (meth)acrylates according to formula (II) is especially advantageous for metal surfaces (aluminum, anodized aluminum etc.).

Organosilanes improve adhesion to glass and ceramic surfaces.

Metal (meth)acrylates are also advantageous for bonding to metal surfaces for example.

It goes without saying that mixtures of different adhesion promoters may also be employed.

The proportion of the adhesion promoter optionally present in component K1 is preferably between 1% and 3% by weight, based on component K1.

Furthermore the composition in component K1 may preferably additionally contain at least one core-shell polymer. Core-shell polymers consist of an elastic core polymer (core) and a rigid shell polymer (shell). Especially suitable core-shell polymers consist of a rigid shell of a rigid thermoplastic polymer grafted onto a core of crosslinked elastic acrylate or butadiene polymer. Particularly suitable core-shell polymers are those which swell up in monomer A and/or co-monomer B but do not dissolve therein.

Preferred core-shell polymers are so-called MBS polymers which are commercially available for example under the trade name Clearstrength® from Arkema Inc., USA, or Paraloid® from Rohm and Haas, USA. The core-shell polymers are preferably employed in an amount of 0.01% to 30% by weight, in particular of 5% to 20% by weight, based on component K1.

Furthermore, the composition in component K1 may additionally preferably contain at least one activator for free-radical curing, also referred to as a catalyst. The activator is in particular a tertiary amine, a transition metal salt or a transition metal complex. Examples of such suitable tertiary amines are N,N-dimethylaniline, N, N-diethylaniline, N,N-dimethyl-p-toluidine, N, N-diethyl-p-toluidine, N-methyl-N-hydroxyethyl-p-toluidine, N,N-bis(2-hydroxyethyl)-p-toluidine and alkoxylated N, N-bis(hydroxyethyl)-p-toluidines, N-ethoxylated p-toluidine, N-alkylmorpholine and mixtures thereof. Transition metal salts and transition metal complexes are for example salts and complexes of cobalt, nickel, copper, manganese or vanadium. Mixtures of such substances may also be used as activator. N,N-bis(2-hydroxyethyl)-para-toluidine is most preferred as activator.

The activator is preferably employed in an amount of 0.01% to 2.5% by weight, in particular of 0.5% to 2.5% by weight, based on component K1.

It is preferable when the composition in component K1 additionally contains an inhibitor for free-radical curing. This is selected from substances which slightly retard or moderate the free-radical mechanisms of curing or inhibit undesired curing reactions (for example UV light- or atmospheric oxygen-induced mechanisms), thus leading to improved storage stability and/or a more controlled, more uniform curing.

It is preferable when component K1 contains between 0.001% by weight and 0.5% by weight, based on component K1, of at least one inhibitor for free-radical curing, in particular an alkylated phenol, preferably 2,6-di-tert-butyl-p-cresol.

Furthermore, component K1 may preferably additionally contain at least one filler. Especially suitable fillers include natural, ground or precipitated calcium carbonates (chalks), which are optionally coated with fatty acids, in particular stearates, montmorillonites, bentonites, barium sulfate (BaSO₄, also known as barite or heavy spar), calcined kaolins, quartz flour, aluminum oxides, aluminum hydroxides, silicas, in particular pyrogenic silicas, modified castor oil derivatives and polymer powders or polymer fibers. Preference is given to calcium carbonates, in particular coated calcium carbonates. The fillers that are most preferred are coated calcium carbonate and/or pyrogenic silica.

The filler is typically employed in an amount of 0.01% to 55% by weight, in particular of 2.5% to 40% by weight, preferably 5% to 45% by weight, based on component K1.

The second component K2 of the two-component composition comprises at least one initiator for free-radical curing. The initiator is a free-radical former that forms reactive free-radicals, thus initiating the free-radical curing mechanism of the monomers in component K1.

Molecules suitable as such free-radical formers are in particular those which, under the influence of heat or electromagnetic radiation, form free-radicals which then result in polymerization of the composition.

Free-radical formers especially include thermally activatable free-radical formers and photoinitiators.

Preferred thermally activatable free-radical formers especially include those which are still sufficiently stable at room temperature but form free-radicals at even slightly elevated temperature. Such free-radical formers include in particular a peroxide, a perester or a hydroperoxide. Organic peroxides are preferred. Dibenzoyl peroxide is most preferred.

Photoinitiators are free-radical formers which form free-radicals under the influence of electromagnetic radiation. Especially suitable photoinitiators include those which form free-radicals upon irradiation with electromagnetic radiation having a wavelength of 230 nm to 400 nm and are liquid at room temperature.

It is particularly preferable when the photoinitiator is selected from the group consisting of a-hydroxyketones, phenylglyoxylates, monoacylphosphines, diacylphosphines, phosphine oxides and mixtures thereof, in particular 1-hydroxycyclohexylphenylketone, benzophenone, 2-hydroxy-2-methyl-1-phenylpropanone, methylphenyl glyoxylate, oxyphenylacetic acid 2-[2-oxo-2-phenyl-acetoxyethoxylethyl ester, oxyphenylacetic acid 2-[2-hydroxyethoxy]ethyl ester, diphenyl(2,4,6-trimethylbenzoyl) phosphine oxide, phenylbis(2,4,6-trimethylbenzoyl) phosphine oxide and mixtures thereof. Such photoinitiators are for example commercially available from the IRGACURE® and DAROCUR® product lines of Ciba Specialty Chemicals, Switzerland. Mixtures of photoinitiators may also be used.

Component K2 of the two-component composition preferably contains between 5% by weight and 75% by weight, based on component K2, of the at least one initiator for free-radical curing, wherein said initiator is especially a thermally activatable free-radical former, preferably a peroxide, a hydroperoxide or a perester, most preferably dibenzoyl peroxide, or wherein said initiator is a photoinitiator, in particular a photoinitiator which forms free-radicals upon irradiation with electromagnetic radiation having a wavelength of 230 nm to 400 nm.

Dibenzoyl peroxide is most preferred as the initiator in component K2. This is preferably employed dispersed in a plasticizer.

Component K2 of the composition according to the invention preferably additionally contains at least one additive selected from the group consisting of plasticizer, filler, thixotropic additive and colorant, in particular all of these additives.

Suitable plasticizers include all nonreactive substances which are liquid at room temperature and typically employed in (meth)acrylate compositions in this function.

Suitable fillers include for example the same fillers as described for component K1.

Suitable colorants include nonreactive organic dyes and pigments.

Suitable thixotropic additives include all such additives typically used in (meth)acrylate compositions.

The composition may optionally additionally contain further constituents in one or both components. Such additional constituents include impact modifiers, dyes, pigments, inhibitors, UV- and heat-stabilizers, metal oxides, antistats, flame retardants, biocides, plasticizers, waxes, levelling agents, adhesion promoters, thixotropic agents, spacers and further raw materials and additives known to a person skilled in the art.

The composition according to the invention is a two-component composition, wherein the two components K1 and K2 are stored separately from one another until application. The first component K1 especially includes those ingredients of the described composition which comprise free-radically polymerizable groups. The second component K2 especially includes the free-radical formers, also known as initiators. A two-component composition also makes it possible to effect separate storage of other constituents, in particular those that impair the storage stability of the composition through reaction with one another.

In the described two-component compositions it is typically the case that component K1 comprises the constituents monomers, elastomers, core-shell polymers, catalysts, adhesion promoters, pigments and fillers and component K2 comprises the constituents free-radical initiator, pigments and fillers. The mixing ratio of K1 to K2 is especially in the range from 1:1 to 10:1.

In certain cases it may be advantageous to give the two components K1 and K2 different colors. This allows the mixing quality to be checked during mixing of the components and mixing errors can be detected at an early stage. This measure also allows qualitative checking of whether the intended mixing ratio has been observed.

A further aspect of the invention relates to a package composed of a packaging and packaged material.

The packaging comprises two chambers separated from one another. The packaged material is a two-component free-radically cured composition consisting of a first component K1 and a second component K2 as described above. Component K1 is in one chamber of the packaging and component K2 is in the other chamber of the packaging.

The packaging especially forms a unit in which the two chambers are held together or directly bound to one another.

The separating means between the chambers may for example be a film or a breakable layer or one or two closures sealing an opening. In a preferred embodiment the packaging is a double cartridge.

Such cartridge packagings are prior art for two-component compositions and disclosed for example in WO2008151849.

A further packaging option is a multi-chamber tubular bag or a multi-chamber tubular bag with an adapter, as disclosed for example in WO 01/44074 A1.

It is preferable when the mixing of the two components K1 and K2 is effected using a static mixer which may be attached to the packaging with two chambers preferably used for this process.

In an industrial-scale plant, the two components K1 and K2 are typically stored separately from one another in vats or hobbocks and expressed and mixed on application, for example using gear pumps. The composition may be applied to a substrate manually or in an automated process using a robot.

The invention further comprises the use of a composition as described hereinabove as an adhesive or sealant or for producing coatings, in particular as a structural adhesive. The invention especially comprises the use of the composition for the bonding of glass and ceramic substrates with plastics and/or metals or for the bonding of metals with one another. The composition is particularly suitable for the bonding of substrates, in particular of metallic substrates, that have not been fully de-oiled or degreased before bonding.

The substrate on whose surface the mixed composition is applied may have been subjected to prior treatment with suitable pretreatment or cleaning agents. It is particularly suitable to effect pretreatment/cleaning of the substrates with Sika® Cleaner P or Sika® ADPrep which are commercially available from Sika Schweiz AG.

Pretreatment of the substrates with primers and/or adhesion promoters may be useful in certain cases but compositions according to the invention have proven particularly advantageous because they may be applied primerlessly to numerous substrates, in particular to glass, PVC and aluminum, without adverse effects on adhesion.

The invention further comprises a process for bonding substrates S1 and S2 comprising the steps of
i) applying a composition as described above to a substrate S1
ii) contacting the applied composition with a second substrate S2 within the open assembly time;

or
i′) applying a composition as described above to a substrate S1
ii′) applying a composition as described above to a substrate S2
iii′) joining the two substrates S1 and S2, to which composition has been applied, within the open assembly time;

wherein the second substrate S2 is composed of a material identical or different to that of substrate S1. Step i) or i′) and ii′) are preceded by a step I) of at least partial mixing of the two components.

The invention further comprises a process of sealing or coating a substrate S1 comprising the steps of
i″) applying a composition as described above to a substrate S1;
ii″) curing the composition.

Step i″) is preceded by a step I) of at least partial mixing of the two components.

The present invention further comprises a cured composition obtained from an above-described composition by a curing process. In cured form the composition has the feature that it does not exhibit viscoelastic behavior and that compressive stress results in no, or almost no, plastic deformation of the composition.

The invention further comprises articles bonded or sealed by an above-described process. These articles are preferably a built structure, in particular an above- or below-ground built structure, or an industrial product or a consumer good, in particular a window, a domestic appliance, a tool or a means of transport, in particular a vehicle for travelling on water or land, preferably an automobile, a bus, a truck, a train or a ship. Such articles are preferably also attachable components for industrial products or means of transport, in particular also modular parts, which are used as modules on the manufacturing line and in particular attached or installed by bonding. These prefabricated attachable components are especially employed in the construction of means of transport. Such attachable components include for example driver's cabs of trucks or of locomotives or sunroofs of automobiles. These articles are preferably windows and doors, such as are used in built structures.

### EXAMPLES

Examples illustrating the invention are described below.

### Employed Diols and Diisocyanates in Elastomers C1 to C12

TABLE 1
Details of the investigated elastomers C. All elastomers
C were reacted with hydroxyethyl methacrylate (HEMA).

| Elastomer | Diol D | Diol type | Diisocyanate |
|---|---|---|---|
| C1 | Priplast ® 1837 (Croda) | Dimer fatty acid- | IPDI ¹ |
| | | based polyester diol | |
| C2 | Acclaim ® 4200 (Covestro) | Polyether diol | IPDI |
| C3 | Priplast ® 1837 (Croda) | Dimer fatty acid- | MDI ² |
| | | based polyester diol | |
| C4 | Priplast ® 1837 (Croda) + | Dimer fatty acid- | IPDI |
| | Acclaim ® 4200 (Covestro) | based polyester diol + | |
| | (weight ratio 1:1) | polyether diol | |
| C5 | Acclaim ® 4200 (Covestro) | Polyether diol | MDI |
| C6 | Desmophen ® 5031 | Polyether triol | MDI |
| | (Covestro) | | |
| C7 | Desmophen ® 1652 | Polyester diol (not | IPDI |
| | (Covestro) | dimer fatty acid- | |
| | | based) | |
| C8 | PolyTHF ® 650 (BASF) | Polyether diol | IPDI |
| C9 | EBECRYL ® 246/20HEMA (Allnex) - commercial aliphatic | | |
| | urethane acrylate | | |
| C10 | Priplast ® 3196 (Croda) | Dimer fatty acid- | IPDI |
| | | based polyester diol | |
| C11 | Priplast ® 3196 (Croda) + | Dimer fatty acid- | IPDI |
| | Acclaim ® 4200 (Covestro) | based polyester diol + | |
| | (weight ratio 1:1) | polyether diol | |
| C12 | Priplast ® 3196 (Croda) | Dimer fatty acid- | HDI ³ |
| | | based polyester diol | |

¹ isophorone diisocyanate;
² diphenylmethane diisocyanate;
³ hexamethylene 1,6-diisocyanate.

### Production of an Elastomer C

The elastomer C5 was produced as follows:

849 g of polyoxypropylene diol (Acclaim® 4200, Covestro; OH number 28.5 KOH/g) and 101 g of 1-isocyanato-3,3,5-trimethyl-5-isocyanatomethylcyclohexane (=isophorone diisocyanate or IPDI; Desmodur® I, Bayer MaterialScience) were reacted at 60° C. to afford an isocyanate-terminated polyurethane polymer having a titrimetrically determined content of free isocyanate groups of 1.88% by weight. This was followed by addition of 10 g of hydroxyethyl methacrylate (HEMA) which reacted with the free isocyanate groups of the polyurethane polymer to afford the elastomer C5.

The remaining elastomers C1 to C4, C6 to C8 and C10 to C12 were produced analogously from the respective raw materials in table 1. Elastomer C9 is a commercially available product not based on dimer fatty acid-based polyester diols.

### Production of the Compositions

The following compositions were produced:

As component K1 to be tested the constituents specified in tables 2 and 3 in the reported amounts were mixed with one another and incorporated in a dissolver at a temperature of not more than 80° C. until a macroscopically homogeneous paste was obtained.

As component K2, 46.5% by weight of dibenzoyl peroxide (20% strength) in plasticizers, 50% by weight of chalk, 3% by weight of thixotropic agent and 0.5% by weight of a pigment were mixed with one another in a dissolver. This component K2 was used with the respective component K1 from tables 2 and 3 for all experiments.

The produced components K1 and K2 were filled into the separate chambers of coaxial cartridges and, in use, employed in a K1:K2 volume ratio of 10:1.

### Description of the Test Methods

The adhesion of the adhesive was tested by means of a tensile shear strength test and analysis of the fracture pattern. Tensile shear strength was determined based on ISO 4587/DIN EN 1465 on a Zwick/Roell Z010 tensile tester, in each case using untreated AlMg₃ substrates (dry) and oiled AlMg₃ substrates (adhesive surface: 15×45 mm; film thickness: 1.6 mm; measuring rate: 10 mm/min; temperature: 23° C.).

The oil used for oiling the oiled substrates was ANTICORIT® PL 3802-39S (Fuchs Lubritech, Germany) which was applied to the steel sheets at a rate of 3 g/m². The fracture pattern was assessed as predominantly cohesive (CF) or predominantly adhesive (AF). A predominantly cohesive fracture pattern shows good adhesion of the adhesive to the substrate.

The results of the measurements are summarized in table 4.

TABLE 2
Inventive components K1 and reference components
K1 (marked with *). All figures in percent by
weight based on the respective component K1.

| | Example | | | | | |
|---|---|---|---|---|---|---|
| | E1 | R1* | E2 | E3 | R2* | R3* |
| Benzyl | 40.97 | 40.97 | 40.97 | 40.97 | 40.97 | 40.97 |
| methacrylate | | | | | | |
| Inhibitor ¹ | 0.05 | 0.05 | 0.05 | 0.05 | 0.05 | 0.05 |
| Elastomer C1 | 20.0 | — | — | — | — | — |
| Elastomer C2 | — | 20.0 | — | — | — | — |
| Elastomer C3 | — | — | 20.0 | — | — | — |
| Elastomer C4 | — | — | — | 20.0 | — | — |
| Elastomer C5 | — | — | — | — | 20.0 | — |
| Elastomer C6 | — | — | — | — | — | 20.0 |
| Filler 1 ² | 5.0 | 5.0 | 5.0 | 5.0 | 5.0 | 5.0 |
| Filler 2 ³ | 30.0 | 30.0 | 30.0 | 30.0 | 30.0 | 30.0 |
| Activator ⁴ | 0.98 | 0.98 | 0.98 | 0.98 | 0.98 | 0.98 |
| Adhesion | 3.0 | 3.0 | 3.0 | 3.0 | 3.0 | 3.0 |
| promoter ⁵ | | | | | | |

¹ 2,6-di-tert-butyl-p-cresol;
² HDK ® 18 (Wacker);
³ Socal ® U1S2 (Solvay);
⁴ N,N-bis(2-hydroxyethyl)-para-toluidine;
⁵ Sartomer ® SR9051 (Arkema).

TABLE 3
Inventive components K1 and reference components
K1 (marked with *). All figures in percent by
weight based on the respective component K1.

| | Example | | | | | |
|---|---|---|---|---|---|---|
| | R4* | R5* | R6* | E4 | E5 | E6 |
| Benzyl | 40.97 | 40.97 | 40.97 | 40.97 | 40.97 | 40.97 |
| methacrylate | | | | | | |
| Inhibitor ¹ | 0.05 | 0.05 | 0.05 | 0.05 | 0.05 | 0.05 |
| Elastomer C7 | 20.0 | — | — | — | — | — |
| Elastomer C8 | — | 20.0 | — | — | — | — |
| Elastomer C9 | — | — | 20.0 | — | — | — |
| Elastomer C10 | — | — | — | 20.0 | — | — |
| Elastomer C11 | — | — | — | — | 20.0 | — |
| Elastomer C12 | — | — | — | — | — | 20.0 |
| Filler 1 ² | 5.0 | 5.0 | 5.0 | 5.0 | 5.0 | 5.0 |
| Filler 2 ³ | 30.0 | 30.0 | 30.0 | 30.0 | 30.0 | 30.0 |
| Activator ⁴ | 0.98 | 0.98 | 0.98 | 0.98 | 0.98 | 0.98 |
| Adhesion | 3.0 | 3.0 | 3.0 | 3.0 | 3.0 | 3.0 |
| promoter ⁵ | | | | | | |

¹ 2,6-di-tert-butyl-p-cresol;
² HDK ® 18 (Wacker);
³ Socal ® U1S2 (Solvay);
⁴ N,N-bis(2-hydroxyethyl)-para-toluidine;
⁵ Sartomer ® SR9051 (Arkema).

TABLE 4
Adhesion measurements (tensile shear strength and fracture
pattern) of the exemplary compositions produced.

| | Substrate | | | |
|---|---|---|---|---|
| | AlMg₃ (dry) | | AlMg₃ (oiled) | |
| | Tensile shear | Fracture | Tensile shear | Fracture |
| Example | strength [MPa] | pattern | strength [MPa] | pattern |
| E1 | 11.5 | CF | 10.7 | CF |
| R1 | 11.6 | CF | 7.6 | AF |
| E2 | 10.8 | CF | 9.5 | CF |
| E3 | 11.2 | CF | 10.6 | CF |
| R2 | 10.8 | CF | 8.1 | AF |
| R3 | 12.0 | CF | 8.4 | AF |
| R4 | 11.8 | CF | 7.2 | AF |
| R5 | 12.9 | CF | 3.5 | AF |
| R6 | 8.8 | CF | 5.8 | AF |
| E4 | 11.3 | CF | 10.2 | AF |
| E5 | 10.5 | CF | 9.5 | CF |
| E6 | 10.7 | CF | 8.2 | AF |

The results in table 4 show that only inventive compositions containing an elastomer C, which is at least partially based on dimer fatty acid-based polyester diol, result in good adhesion and a cohesive fracture pattern on oiled substrates. The best results are obtained when elastomer C is also based on IPDI. In these cases both a purely cohesive fracture pattern and comparatively the highest tensile shear strengths are obtained.

1. A two-component composition consisting of a component K1, comprising
a) at least one (meth)acrylate monomer;
b) at least one elastomer having (meth)acrylate end groups;
c) at least one additive selected from the group consisting of activator for free-radical curing, inhibitor for free-radical curing, filler and adhesion promoter;
and a component K2 comprising at least one initiator for free-radical curing;
wherein the elastomer is a polyurethane (meth)acrylate produced from the reaction of at least one diol comprising at least one dimer fatty acid-based polyester diol with at least one diisocyanate and a (meth)acrylic acid, a (meth)acrylamide or a (meth)acrylate ester having a hydroxyl group, wherein
the at least one diol initially reacts with the diisocyanate which is present in stoichiometric excess;
and the resulting isocyanate-terminated polyurethane is subsequently reacted with the (meth)acrylic acid, the (meth)acrylamide or the (meth)acrylate ester having a hydroxyl group to afford the elastomer.

2. The two-component composition as claimed in claim 1, wherein the diisocyanate for the production of the elastomer is isophorone diisocyanate.

3. The two-component composition as claimed in claim 1, wherein the elastomer has an average molecular weight measured by gel permeation chromatography of 2000 to 5000 g/mol.

4. The two-component composition as claimed in claim 1, wherein the (meth)acrylate ester having a hydroxyl group used for the production of the elastomer is a hydroxyalkyl (meth)acrylate.

5. The two-component composition as claimed in claim 1, wherein the diol used for the production of the elastomer consists to a mass fraction of at least half of at least one dimer fatty acid-based polyester diol.

6. The two-component composition as claimed in claim 1, wherein the composition in component K1 additionally contains between 0.5% by weight and 5% by weight, based on component K1, of an adhesion promoter selected from the list of organosilanes, metal (meth)acrylates, preferably metal (meth)acrylates of calcium, magnesium or zinc, polyfunctional (meth)acrylates having more than two (meth)acrylate groups and (meth)acrylates of formula (II), 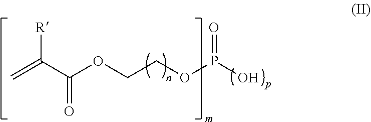
wherein R′ is either a hydrogen atom or a methyl group;
n represents a value of 1 to 15;
m represents a value of 1 to 3;
and p represents a value of 3 minus m;
2-methacryloyloxyethyl phosphate, bis(2-methacryloyloxyethyl) phosphate and tris(2-methacryloyloxyethyl) phosphate and mixtures thereof.

7. The two-component composition as claimed in claim 1, wherein the composition in component K1 additionally contains between 0.5% by weight and 2.5% by weight, based on component K1, of at least one activator for free-radical curing.

8. The two-component composition as claimed in claim 1, wherein the composition in component K1 additionally contains between 5% by weight and 45% by weight, based on component K1, of at least one filler.

9. The two-component composition as claimed in claim 1, wherein the composition in component K1 additionally contains between 0.001% by weight and 0.5% by weight, based on component K1, of at least one inhibitor for free-radical curing.

10. The two-component composition as claimed in claim 1, wherein component K2 of the composition contains between 5% by weight and 75% by weight, based on component K2, of the at least one initiator for free-radical curing which forms free-radicals upon irradiation with electromagnetic radiation having a wavelength of 230 nm to 400 nm.

11. The two-component composition as claimed in claim 1, wherein the (meth)acrylate monomer comprises at least one monomer selected from benzyl acrylate, benzyl methacrylate, hydroxyethyl acrylate, hydroxyethyl methacrylate, tetrahydrofurfuryl methacrylate, cyclohexyl methacrylate, isobornyl methacrylate, trimethylcyclohexyl methacrylate, lauryl tetradecyl acrylate, lauryl tetradecyl methacrylate, stearyl acrylate, stearyl methacrylate and any desired mixtures thereof, wherein the two-component composition is free from methyl methacrylate.

12. An adhesive or sealant for producing coatings comprising the two-component composition as claimed in claim 1.

13. A method comprising:
bonding metallic substrates that have not been fully de-oiled or degreased before bonding with the adhesive or sealant according to claim 12.

14. A process for bonding substrates S1 and S2 comprising the steps of
i) applying a composition as claimed in claim 1 to a substrate S1;
ii) contacting the applied composition with a second substrate S2 within the open assembly time;
or
i′) applying a composition as claimed in claim 1 to a substrate S1;
ii′) applying a composition as claimed in claim 1 to a substrate S2;
iii′) joining the two substrates S1 and S2, to which composition has been applied, within the open assembly time;
wherein the second substrate S2 is composed of a material identical or different to that of substrate S1;
and wherein step i) or i′) and ii′) are preceded by a step I) of partial or complete mixing of the two components K1 and K2.

15. An article bonded by a process as claimed in claim 14, wherein the article is a building or an above- or below-ground built structure, an industrially manufactured product or a consumer good.
